(19) United States
(12) Patent Application Publication
(10) Pub. No.: US 2025/0181905 A1
(43) Pub. Date: Jun. 5, 2025

(54) NEURAL NETWORKS PROCESSING UNITS PERFORMANCE OPTIMIZATION

(71) Applicant: Neuronix AI Labs Inc., Sunnyvale, CA (US)

(72) Inventor: Asher Hazanchuk, Sunnyvale, CA (US)

(21) Appl. No.: 19/048,703

(22) Filed: Feb. 7, 2025

Related U.S. Application Data
(63) Continuation of application No. 17/457,623, filed on Dec. 3, 2021, now abandoned.
(63) Continuation of application No. 18/328,635, filed on Jun. 2, 2023.
Application No. 18/328,635 is a continuation-in-part of application No. 17/457,623, filed on Dec. 3, 2021, now abandoned.
(60) Provisional application No. 63/123,784, filed on Dec. 10, 2020.

(51) Int. Cl. G06N 3/063; G06F 9/38; G06N 3/04; G06N 3/08

(52) U.S. Cl. CPC G06N 3/063; G06F 9/3893; G06N 3/04; G06N 3/08

(57) ABSTRACT

In an example embodiment, a scalable deep neural networks (DNN) accelerator (sDNA) is provided that includes multiple neural networks processing units (NPUs) that are interconnected to provide a flexible DNN that is programmable and scalable. Each NPU includes one or more pruned weights memories and one or more compressed activation memories. Each NPU may include multiple A_LUT memories that are used as multipliers accelerator and a W_LUT memory that are used all together to reduce a number of DNN multiplications. The sDNA may include one or more W map memories and A map memories that provide a sDNA algorithm inputs data that enable skipping of zero weights and zero activations. The sDNA architecture can be generalized into sDNA parallel mode to achieve higher memory bandwidth and throughput. In an embodiment, the sDNA architecture is power-efficient, silicon size-efficient and cost-efficient.

### CROSS-REFERENCE TO RELATED APPLICATION

This application is a continuation of U.S. patent application Ser. No. 17/457,623, filed on Dec. 3, 2021; which claims the benefit of U.S. Patent Application Ser. No. 63/123,784 filed on Dec. 10, 2020. This application is also a continuation of U.S. patent application Ser. No. 18/328,635, filed on Jun. 2, 2023; which is a continuation-in-part of U.S. patent application Ser. No. 17/457,623, filed on Dec. 3, 2021; which claims the benefit of U.S. Patent Application Ser. No. 63/123,784, filed on Dec. 10, 2020; the disclosures of which are incorporated herein by reference in their entireties.

### FIELD

Some embodiments herein relate generally to performance optimization of neural networks processing units (NPUs).

### BACKGROUND

Unless otherwise indicated herein, the materials described herein are not prior art to the claims in the present application and are not admitted to be prior art by inclusion in this section.

Cloud computing and edge computing of artificial intelligence (AI)/machine learning (ML) applications and edge devices (example: smartphones, smart cameras) or other real-time applications that require ML are computation-intensive and often require multi-core and multi-device solutions to match system-required very high processing throughput.

Therefore size-efficient and power-efficient multi-core architectures are highly desirable to reduce solution cost and power consumption. Available solutions are currently based on graphics processing unit (GPU), central processing unit (CPU), field programmable gate array (FPGA), and some dedicated Application-Specific Integrated Circuits (ASICs) and/or Application-Specific Standard Products (ASSPs). These implementation methods are typically memory-size inefficient and have larger-than-needed processing units or in the case of dedicated ASICs/ASSPs don't have the flexibility to adapt to changing machine learning evolving models.

The subject matter claimed herein is not limited to embodiments that solve any disadvantages or that operate only in environments such as those described above. Rather, this background is only provided to illustrate one example technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example, a deep neural network (DNN) parallel processor is flexible, hardware programmable, scalable, and reconfigurable. The DNN parallel processor includes multiple NPUs configured to process AI/ML input data. Each of the NPUs may include an activation (A) map memory, a weight (W) map memory, a compressed A memory, a pruned W memory, a control logic block, a routing multiplexer, a multiplier-accumulator (MAC), and a rectified linear unit (ReLU). The control logic block is coupled to outputs of the A map memory and the W map memory and to inputs of the compressed A memory and the pruned W memory. The routing multiplexer is coupled to outputs of the control logic block, the compressed A memory, and the pruned W memory. The MAC is coupled to an output of the routing multiplexer. The ReLU is coupled to an output of the MAC. The NPUs are connected together to perform DNN functions.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example scalable DNN accelerator (sDNA) that may include multiple NPUs;

FIG. 2 depicts an example of how weights and activations may be stored in memory of the NPUs of FIG. 1;

FIG. 3 is a block diagram of another example sDNA with acceleration of MAC operations;

FIG. 4 is an automotive application research example that articulates why it is important to accelerate real-time machine learning inferencing applications;

FIG. 5 is a table with some machine learning model examples and their potential weight and activation sparsity removal acceleration potential;

FIG. 6 is a prior art 2× weight sparsity removal example of Nvidia Ampere GPU family;

FIG. 7 is a prior art typical multipliers utilization statistics example;

FIG. 8 is an example of generalization of the serial mode sDNA architecture example described herein into a parallel mode sDNA architecture example; and

FIG. 9 illustrates DNN processing unit size-reduction of the sDNA architecture processing unit compared with a typical GPU architecture.

### DETAILED DESCRIPTION

Some embodiments herein relate generally to performance optimization of neural networks processing units and may include parallel processors that operate as DNN accelerators. Target devices for the implementation can be programmable logic devices, ASICs, CPUs, GPUs, tensor processing units (TPUs), digital signal processors (DSPs) and/or ASSPs. More particularly, some example embodiments relate to scalable, adaptable, hardware programmable, optimized size, low power parallel processors that target DNN for ML and/or AI applications. The sDNA architecture and the sDNA algorithm described herein may support common ML design flow (TensorFlow, Caffe, and others) with full transparency.

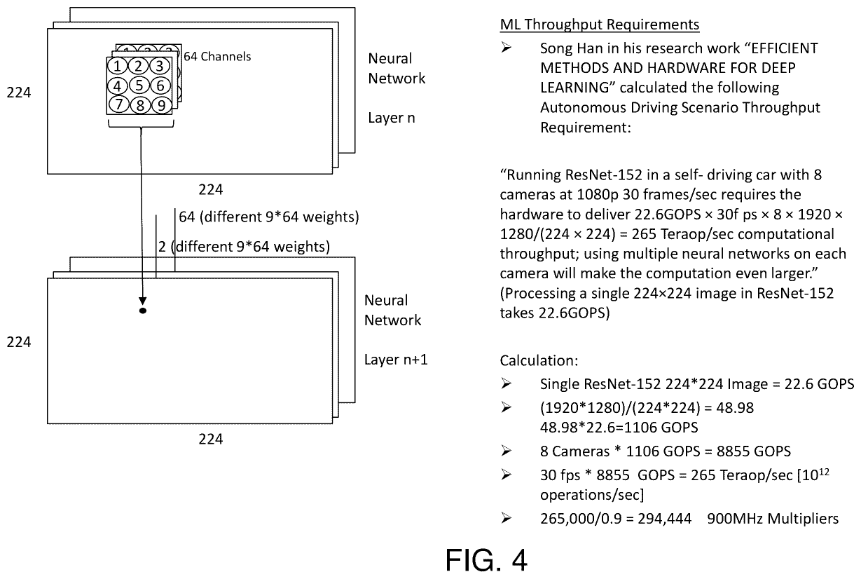

Real-time ML solutions have become very common for many AI applications. The implementation of ML is based on many layers of neural networks called deep neural networks or DNN. There are many different models of DNN: EfficientNet, ResNet, MobileNet, GoogLeNet, SqueezeNet, AlexNet, Vgg, and many others. The common challenges of DNN systems in many real-time applications are a very high throughput that can reach an order of many TeraOps/second (i.e., many 10¹² operations per second). FIG. 4 is an automotive application research example that articulates why it is important to accelerate real-time machine learning inferencing applications. FIG. 4 demonstrates autonomous driving application required throughput as calculated by Song Han in his Stanford research work “EFFICIENT METHODS AND HARDWARE FOR DEEP LEARNING”.

Therefore, the efficiency of the DNN system may be critical to make these applications feasible, low-cost and low-power.

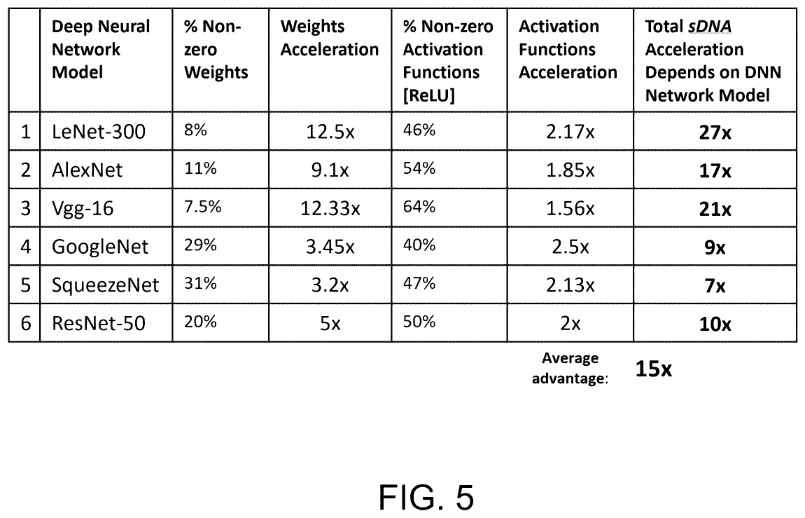

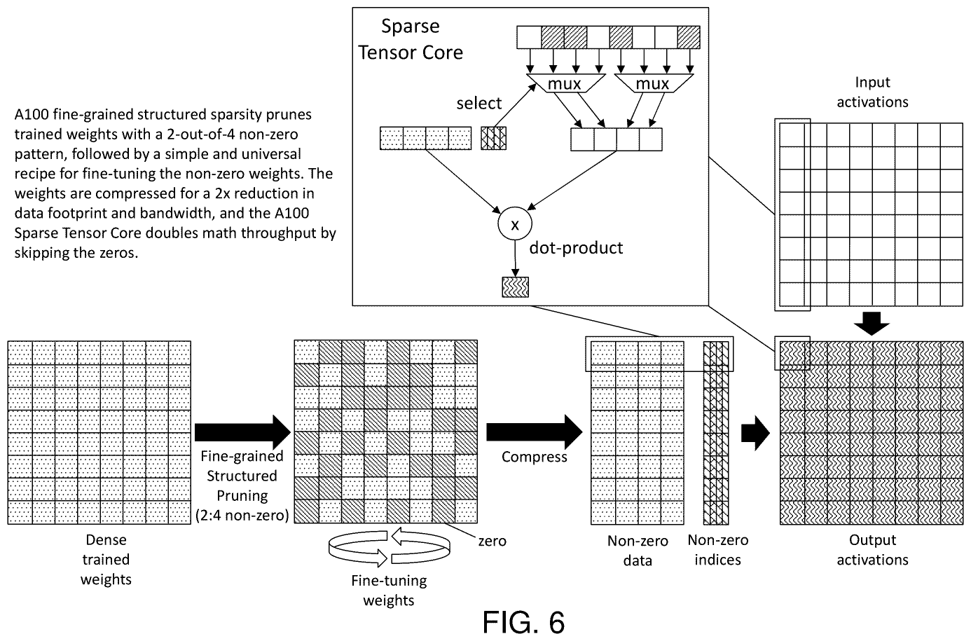

Some calculations that are done in DNN systems include multi-dimensional matrix multiplications between weights and activations multi-dimensional matrixes. A characteristic of such matrixes is that most of the weights and a significant number of activations are zero or could be forced to zero without significant effect on quality of results. This high sparsity presents an opportunity to increase the DNN efficiency. In an example implementation, the DNN acceleration is achieved by removal of this sparsity (multiplication by zero). FIG. 5 demonstrates the approximate acceleration potential due to weight and/or activation sparsity removal of some DNN models. The problem is the irregularity of the non-zero operand locations that make it challenging to implement it in real-time, high clock rate, and high-throughput hardware. In order to overcome this sparsity irregularity-challenge some companies choose to force weight sparsity regularity. For example, Nvidia released in 2020 their Ampere GPU family that as described in FIG. 6 (source: Nvidia datasheet) forces the 2 lowest weight values out of each 4 weight values to zero. This method enables Nvidia to achieve 2× acceleration due to this weight sparsity removal.

In contrast to Nvidia's sparsity removal method, some embodiments herein enable a full removal of all zero weights and all zero activation, regardless of structure, sparsity percentage or distribution, with no performance degradation. This DNN acceleration may be achieved by using a silicon size-efficient and power-efficient implementation as described herein.

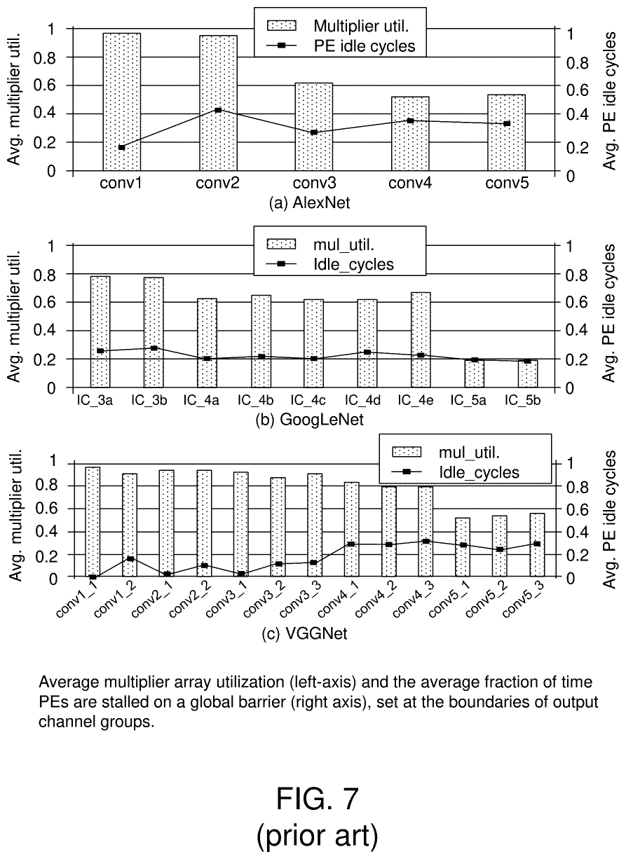

Another advantage of the sDNA architecture as described herein is that in some configurations the sDNA processing units are able independently to start a new DNN calculation and there is no requirement to wait for the other sDNA processing units to finish their calculations before starting a new DNN calculation (no synchronization requirement). This is a major efficiency and acceleration issue to other prior art competing DNN architectures as demonstrated in FIG. 7 (Source: A. Parashar/Nvidia article “SCNN: An accelerator for compressed-sparse CNN”).

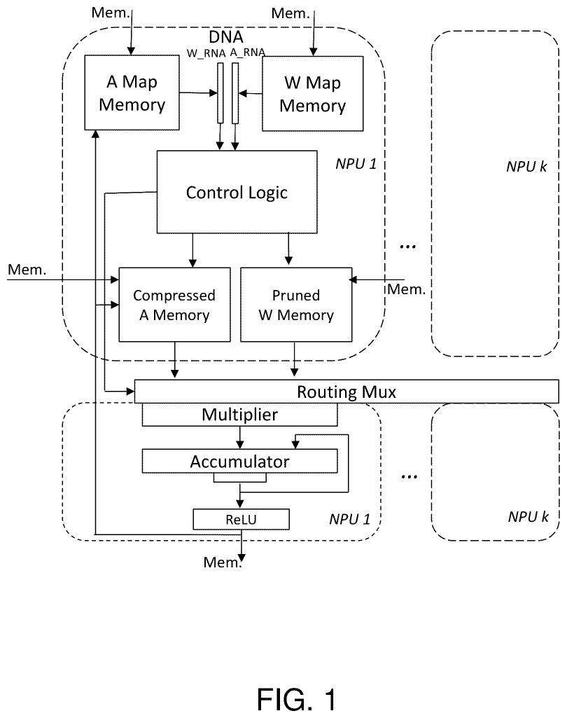

FIG. 1 is a block diagram of an example sDNA that may include multiple NPUs, arranged in accordance with at least one embodiment described herein. The sDNA may also be referred to as a DNN parallel processor. The sDNA or DNN parallel processor may be flexible, hardware programmable, scalable, and reconfigurable. The sDNA of FIG. 1 may be based on parallel processing of multiple NPUs and may include an A map memory and W map memory. The W map memory contains a weights bit-map of the different DNN layers. The A map memory contains an activations bit-map of the different DNN layers.

The sDNA of FIG. 1 additionally includes W_RNA and A_RNA, each of which is a word of 64 bits, 32 bits, 16 bits, 8 bits, or any other bit width. A pair of W_RNA and A_RNA words is a DNA word. Based on the DNA word a control logic block in the sDNA may calculate next clock addresses of a weight (W) address accumulator and an A address accumulator. These addresses point on a next weight and next activation to be fetched from a pruned W memory and a compressed A memory.

The control logic block may also calculate an amount of multiplications contained in each DNA word. This information may be used to control a routing multiplexer (mux). The routing mux may balance the calculation load of different multiplier-accumulators of the different NPUs. The multiplier-accumulators may calculate nodes (neuron's activation functions) of the neural networks. After each vector multiplication calculation is completed optionally a non-linear operation such as ReLU or other non-linear functions may be applied before storing the non-zero results in the compressed A memory and its bit map representation at the A Map Memory or at Mem. (as will be described later).

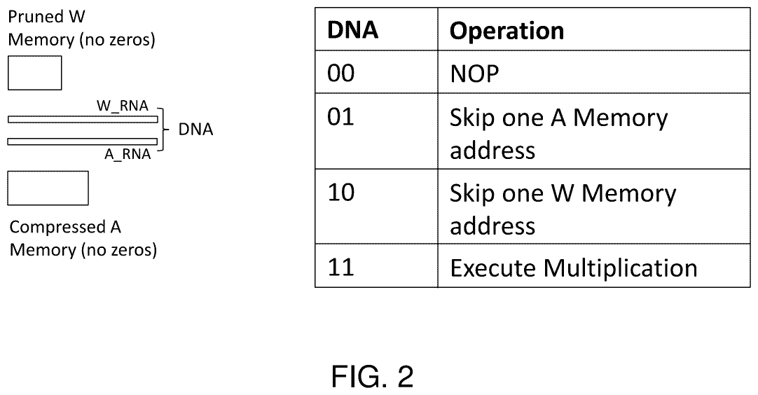

FIG. 2 depicts an example of how the weights and activations may be stored in memory of the NPUs of FIG. 1, arranged in accordance with at least one embodiment described herein. All the zero values may be removed from the original W and/or A memories (e.g., memories that include zeros that have been eliminated in the compressed A memory and the pruned W memory of FIG. 1) and the remaining W and A values may be stored compressed (e.g., without zeroes) at the Pruned W and Compressed A Memories. In addition, the W_RNA word is fetched from the W Map Memory and the A_RNA word is fetched from the A Map Memory. Each pair of W_RNA and A_RNA words create a word of DNA. As described in the table of FIG. 2 each pair of bits define a microcode operation to be executed in parallel. Multiple pairs are executed in parallel to locate the next required multiplications.

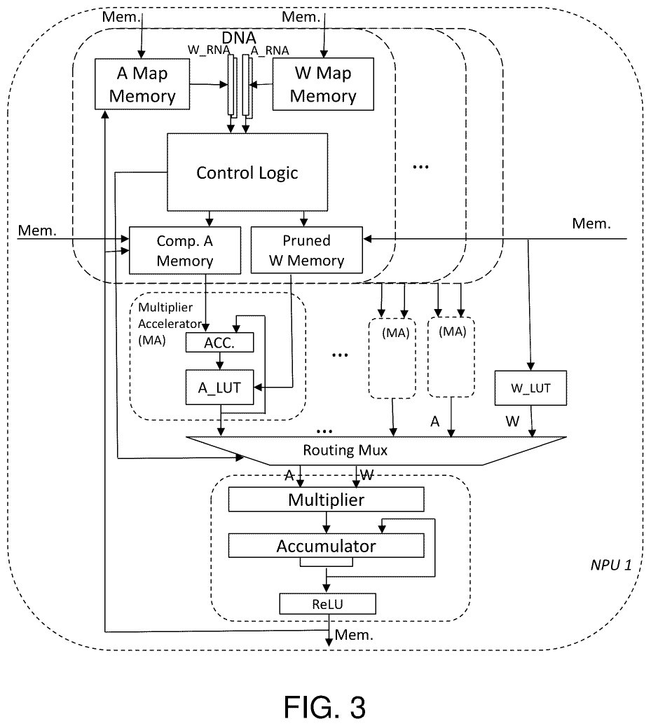

FIG. 3 is a block diagram of another example sDNA or DNN parallel processor with acceleration of MAC operations of the NPU, arranged in accordance with at least one embodiment described herein. In the example of FIG. 3, the acceleration is added into the middle of the sDNA of FIG. 1 and is described here. In FIG. 3, the output of the Pruned W Memory points to an activation_lookup table (A_LUT) memory location. Each location may be used for the accumulation of all the A values that need to be multiplied with specific W value. At the end of calculation of specific activation function, the A accumulations intermediate results, that resides in the A_LUT memory, is each multiplied with its matching W or de-quantized W results that resides in a weight-lookup table (W_LUT) memory. The control logic block controls the sequence of the multiply-accumulate operations and routing mux selections. The weights and activations can switch roles in different design examples.

DNN are used in ML for AI applications. The majority of the calculations that are required for DNN implementations are multi-dimensional matrix multiplications. The multiplications are done between tensors (multi-dimensional matrixes) of weights and tensors of activations of the internal DNN layers or the sensor inputs for the first DNN layer. The multi-dimensional matrix could be a combination of two-dimensional convolution kernel, the number of current DNN layer channels, and the results dimension could be the next DNN layer number of channels. The majority of the weights and the activations may be zeroes or very close to zero (could be forced to zero). Therefore, without removing these zero multiplication operands (which is also called sparsity removal) there is a lot of inefficiency in these DNN implementations that increases the power consumption and cost of these AI/ML systems.

The sDNA of FIG. 1 may use the W Map Memory to map all the zero weights that can be skipped and the A Map Memory to map all the zero activations that can be skipped. An sDNA algorithm implemented herein may slide through each layer of the convolution neural network and by comparing the W_RNA and the A_RNA words fetched from these memories, it may calculate how many weights in the Pruned W Memory and how many activations in the Compressed A Memory may be simultaneously skipped.

As illustrated in FIG. 2, microcode of the DNA operation may be defined by each pair of DNA bits, e.g., as follows:
00—No operation
01—Skip one A memory address
10—Skip one W memory address
11—Execute multiplication
   Multiple microcode instructions may be executed simultaneously in parallel.

The specific weight and activation function operands may be fetched from their respective memory locations in pruned W memory and compressed A memory and then fed to the MAC of the specific NPU after being routed through the routing mux. As indicated in FIG. 1 there may be many (e.g., k) NPUs that execute the sDNA algorithm in parallel to maintain the required DNN ML model and application throughput.

The Control Logic block in FIG. 1 may also calculate how many multiplications are required for each DNA word. This information may be used to balance the multiplications load for each NPU MAC unit. The following is an example of an sDNA algorithm that may use this information to control the data (weights and activation functions) paths in the routing mux and balance its calculation load: each MAC of NPU is allocated a DNA word with a number of multiplications that depends on its calculation's status. The fastest NPU processing unit is allocated the DNA word with the largest number of multiplications, the second fastest NPU is allocated the DNA word with the second largest number of multiplications, and so on until the slowest NPU processing unit is allocated the DNA word with the smallest number of multiplications.

The ReLU, which is a non-linear post-processing function common to many ML models, or other non-linear post-processing functions, may be attached after the MAC and may be executed after the final result of the MAC tensor-multiplication is completed. If the ReLU result is non-zero then 1 is stored in the A Map Memory and its actual value is stored in the Compressed A Memory. Alternatively, this information can be stored in Mem.

Mem. could be an input/output (I/O) interface, internal memory or external memory (DDR for example). In the Mem. image of the activation function data or weights could be stored for later use of the sDNA algorithm.

Some embodiments herein implement a DNN with sparsity removal, as generally described above. Some embodiments herein implement a DNN with multiplier acceleration (MA), as generally described below. Alternatively or additionally, embodiments herein may implement a DNN with both sparsity removal and multiplier acceleration.

In some embodiments that implement multiplier acceleration, for example, it may be possible to take one of the operands of the multiplier, for example, pruned W which is the output of Pruned W Memory, as described in the FIG. 3 example, and to use an Accumulator (ACC. In FIG. 3), memory (A_LUT), and the memory feedback to the Accumulator (ACC.) to reduce an amount of multiplications that are needed for the implementation. Each one of the W different A multiplication components may be accumulated separately. In case of a quantized W mode of operation, memory W_LUT may contain de-quantized components of W. The intermediate results may be accumulated together by the multiplier accumulator to calculate the full activation function result, before it is sent to the ReLU. The multiplier acceleration functions can be bypassed if some of them or all of them are not needed.

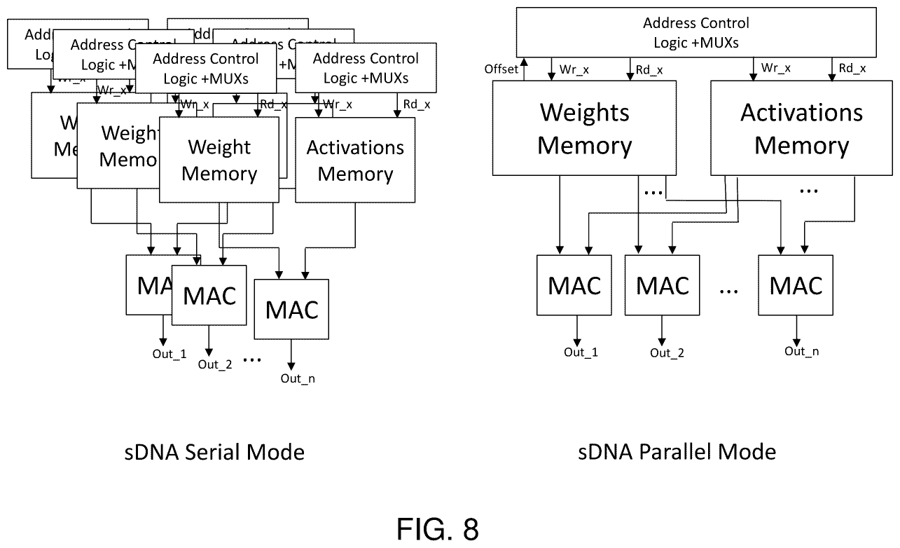

FIG. 8 is an example of generalization of the serial mode sDNA architecture example described herein into a parallel mode sDNA architecture example. As illustrated in FIG. 8, the serial mode that is described in details in this patent application can be generalized to parallel mode to increase memory bandwidth usage. The example of FIG. 8 is only one example of how the sDNA serial mode architecture could be generalized to sDNA parallel mode architecture to achieve higher throughput and performance. Based on the Offsets generated in the Weight memories multiple activations are read in parallel and multiple Activation Function outputs are being calculated simultaneously.

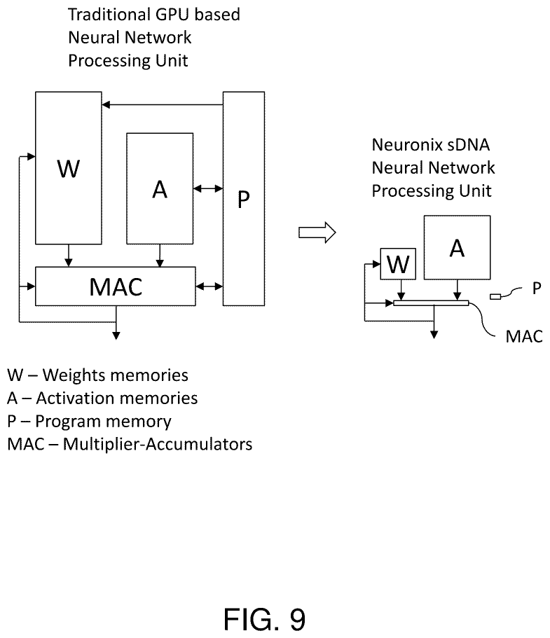

FIG. 9 demonstrates DNN processing unit size-reduction of the sDNA architecture processing unit compared with a typical GPU architecture. As described in FIG. 9, the Neuronix sDNA architecture neural network processing unit and its sparsity removal algorithm reduce the weights and activations memory sizes. The sDNA data flow architecture significantly reduces the required program memory size. The full sparsity removal and the use of multiplier accelerator architecture are reducing the total number of multipliers required. Altogether the size of the basic sDNA processing unit is significantly reduced compared with currently commonly used DNN architectures that are based on GPU, CPU, TPU or other similar DNN solutions.

This patent application describes an hardware implementation of algorithms for, e.g., DNN with sparsity removal and/or multiplier accelerator. Embodiments described herein may also be relevant and/or may be extended to software implementation of the algorithms.

Some portions of the detailed description refer to different modules, components, etc. configured to perform operations. One or more of the modules may include code and routines configured to enable a computing system to perform one or more of the operations described therewith. Additionally or alternatively, one or more of the modules may be implemented using hardware including any number of processors, microprocessors (e.g., to perform or control performance of one or more operations), DSPs, FPGAs, ASICs or any suitable combination of two or more thereof. Alternatively or additionally, one or more of the modules may be implemented using a combination of hardware and software. In the present disclosure, operations described as being performed by a particular module may include operations that the particular module may direct a corresponding system (e.g., a corresponding computing system) to perform. Further, the delineating between the different modules is to facilitate explanation of concepts described in the present disclosure. Further, one or more of the modules may be configured to perform more, fewer, and/or different operations than those described such that the modules may be combined or delineated differently than as described.

In general, all embodiments described herein can be freely combined, as applicable and if compatible. Further, the invention is not limited to the described embodiments, but can be varied within the scope of the enclosed claims.

Unless specific arrangements described herein are mutually exclusive with one another, the various implementations described herein can be combined in whole or in part to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A deep neural network (DNN) parallel processor that is flexible, hardware programmable, scalable, and reconfigurable, the DNN parallel processor comprising a plurality of neural networks processing units (NPUs) configured to process artificial intelligence (AI)/machine learning (ML) input data, each of the plurality of NPUs comprising:
an activation (A) map memory;
a weight (W) map memory;
a compressed A memory;
a pruned W memory;
a control logic block coupled to outputs of the A map memory and the W map memory and to inputs of the compressed A memory and the pruned W memory;
a routing multiplexer coupled to outputs of the control logic block, the compressed A memory, and the pruned W memory;
a multiplier-accumulator (MAC) coupled to an output of the routing multiplexer; and
a rectified linear unit (ReLU) or other non-linear function coupled to an output of the MAC;
wherein the plurality of NPUs are connected together to perform DNN functions.

2. The DNN parallel processor of claim 1, wherein the DNN functions comprise ML DNN functions.

3. The DNN parallel processor of claim 2, wherein the control logic block is configured to calculate an amount of memory locations in the compressed A memory and the pruned W memory to skip based on DNN accelerator (DNA) words.

4. The DNN parallel processor of claim 1, wherein the control logic block is configured to skip all the pruned W memory and the compressed A memory zero-multiplied locations such that all zero multiplications are removed from the DNN calculations for full sparsity removal.

5. The DNN parallel processor of claim 1, wherein the A map memory receives inputs from a Mem. or from the ReLU and wherein the Mem. comprises an internal memory, an external memory, or an input/output (I/O) interface.

6. The DNN parallel processor of claim 1, wherein the W map memory receives inputs from a Mem. and wherein the Mem. comprises an internal memory, an external memory, or an input/output (I/O) interface.

7. The DNN parallel processor of claim 3, wherein:
each of the DNA words comprises a W_RNA word from the W map memory and an A_RNA word from the A map memory; and
each of the W_RNA word and the A_RNA word have a same length of n bits.

8. The DNN parallel processor of claim 1, wherein the control logic block is configured to:
receive DNN accelerator (DNA) words as inputs;
calculate a next address for each of the compressed A memory and the pruned W memory based on the corresponding DNA word; and
calculate connectivity of the routing multiplexer based on the corresponding DNA word.

9. The DNN parallel processor of claim 1, further comprising:
A_LUT memory coupled between the output of the compressed A memory and the routing multiplexer and between the output of the pruned W memory and the routing multiplexer,
W_LUT memory coupled to an input of the routing multiplexer and is connected to input from Mem.

10. The DNN parallel processor of claim 9, wherein:
each of the plurality of NPUs further comprises a plurality of multiplier accelerators that each includes an A_LUT memory and an accumulator coupled between the output of the compressed A memory and the corresponding A_LUT memory;
the multiplier accelerator is configured to receive activation inputs from the compressed A memory and weight inputs from the pruned W memory;
for a given pair of an activation input and a weight input where the weight input has fewer bits than the activation input, the weight input is used as an address of the A_LUT and the activation input is input to the accumulator;
each memory location of the A_LUT is used as an accumulator of the corresponding activation input to be multiplied with the corresponding weight input of the corresponding memory location;
after an activation function is completed, each accumulated location in the A_LUT is multiplied with its corresponding weight input or with a corresponding de-quantized weight input stored at W_LUT; and
the multiplier accelerator is configured to reduce an amount of multiplications of the activation function, in this example, down to 2 power of a number of bits in the weight input from the pruned W memory.

11. The DNN parallel processor of claim 1, wherein the routing multiplexer enables routing different pairs of outputs from compressed A memory and pruned W memory of specific NPUs into inputs of MACs of the same or different NPUs.

12. The DNN parallel processor of claim 1, wherein:
the ReLU is active only at an end of an activation function tensor multiplication calculation;
the ReLU is coupled to an input of the A map memory and an input of the compressed A memory; and
output of the ReLU is stored at the compressed A memory and its map bit is stored at the A map memory.

13. The DNN parallel processor of claim 1, wherein:
the ReLU is active only at an end of an activation function tensor multiplication calculation; and
output of the ReLU is stored at Mem.; and
the Mem. comprises an internal memory, an external memory, or an input/output (I/O) interface.

14. The DNN parallel processor of claim 1, wherein the DNN parallel processor is programmable and reconfigurable.

15. The DNN parallel processor of claim 14, wherein the DNN parallel processor is programmable and reconfigurable seamlessly and transparently using common DNN frameworks, design tools, and design flows.

16. A system comprising:
a deep neural network (DNN) parallel processor that is flexible, hardware programmable, scalable, and reconfigurable, the DNN parallel processor comprising a plurality of neural networks processing units (NPUs) configured to process artificial intelligence (AI)/machine learning (ML) input data, each of the plurality of NPUs comprising:
an activation (A) map memory;
a weight (W) map memory;
a compressed A memory;
a pruned W memory;
a control logic block coupled to outputs of the A map memory and the W map memory and to inputs of the compressed A memory and the pruned W memory;
a routing multiplexer coupled to outputs of the control logic block, the compressed A memory, and the pruned W memory;
a multiplier-accumulator (MAC) coupled to an output of the routing multiplexer; and
a rectified linear unit (ReLU) or other non-linear function coupled to an output of the MAC;
wherein the plurality of NPUs are connected together to perform DNN functions; and
a system processor coupled to each of the plurality of NPUs of the DNN parallel processor, wherein the system processor is configured to enable easy hardware programming with DNN system parameters, DNN weights, sensor inputs, W_LUT values, and re-configurability to support different DNN models.

17. A deep neural network (DNN) parallel processor or generic vector multiplier that is flexible, hardware programmable, scalable, and reconfigurable, the DNN parallel processor comprising a neural networks processing unit (NPU) configured to process artificial intelligence (AI)/machine learning (ML) input data, the NPU comprising:
a weight_lookup table (W_LUT) memory;
a plurality of multiplier accelerators (MAs), each of the MAs comprising:
an accumulator coupled to an output of an activation (A) memory; and
an activation_lookup table (A_LUT) memory coupled to an output of the accumulator and an output of a weight (W) memory;
a routing multiplexer coupled to outputs of the MAs and the W_LUT memory;
a multiplier-accumulator (MAC) coupled to an output of the routing multiplexer; and
a rectified linear unit (ReLU) or other non-linear functions coupled to an output of the MAC;
wherein each of the plurality of MAs is configured to reduce an amount of multiplications of an activation function.

18. The DNN parallel processor of claim 17, further comprising:
A memory coupled to an input of the accumulator; and
W memory coupled to an address input of the A_LUT memory.

19. The DNN parallel processor of claim 18, wherein:
each of the MAs is configured to receive activation inputs from the A memory and weight inputs from the W memory;
for a given pair of an activation input and a weight input where the weight input has fewer bits than the activation input, the weight input is used as an address of the A_LUT memory and the activation input is input to the accumulator;
each memory location of the A_LUT memory is used as an accumulator of the corresponding activation input to be multiplied with the corresponding weight input of the corresponding memory location;
after an activation function is completed, each accumulated location in the A_LUT memory is multiplied with its corresponding weight input or with a corresponding de-quantized weight input stored at the W_LUT memory; and
the MA is configured to reduce the amount of multiplications of the activation function down to 2 power of a number of bits in the weight input from the pruned W memory.

20. The DNN parallel processor of claim 17 operating in parallel mode, wherein:
each of the weight memories information is used in the Address Control Logic block to generate Activation Memories addresses that can be read simultaneously based on calculated offsets to generate multiple Activation Function results simultaneously;
each of the MAs are configured to receive activation inputs from the A memory and weight inputs from the W memory to accelerate the Activation Function outputs calculation;
the DNN parallel mode is accelerated based on at least one of Weights sparsity, Activations sparsity, or Weights and Activations sparsity combined together.
